(19) United States
(12) Patent Application Publication
(10) Pub. No.: US 2023/0166138 A1
(43) Pub. Date: Jun. 1, 2023

(54) Seal for an aircraft and aircraft incorporating at least one such seal

(71) Applicant: JPR, Paris (FR)

(72) Inventors: Romain TUFFERY, AMIENS (FR); Loïc PICARD, PAUCOURT (FR)

(21) Appl. No.: 17/994,878

(22) Filed: Nov. 28, 2022

(30) Foreign Application Priority Data
Nov. 29, 2021 (FR) 2112682

(51) Int. Cl. A62C 3/08; C08L 83/04; C08K 3/04

(52) U.S. Cl. CPC A62C 3/08; C08L 83/04; C08K 3/04; C08L 2201/02

(57) ABSTRACT

The invention relates to a seal for an aircraft incorporating a fire-resistant structure, and an aircraft incorporating at least one such a seal between structural elements of the aircraft connected to each other at a zone of the latter which may be a fire zone according to the standard ISO 2685:1998 or AC 20-135.

According to the invention, this seal (10) comprises:
a seal body (11) at least partially elastomeric, the seal body defining at least one generally tubular or annular cavity (10A), and
a fire-resistant structure (12) distinct from the seal body and disposed inside the cavity, the fire-resistant structure comprising an intumescent mass able to fill the cavity (10A) in an expanded state,
   the intumescent mass being made of a rubber composition having an intumescence trigger temperature equal to or higher than 270° C., measured by a plane-plane rotary rheometer with a temperature scan from 23 to 380° C. according to a ramp of 10° C./min.

### TECHNICAL FIELD

The invention relates to a seal for an aircraft incorporating a fire-resistant structure, and an aircraft incorporating at least one such seal between structural elements of the aircraft connected to each other at a zone of the latter which may be a fire zone according to the standard ISO 2685:1998 or the standard AC 20-135 of the FAA (Federal Aviation Administration). In particular, the invention applies to generally tubular seals for sealing and protecting from fire zones of an airplane or a helicopter selected from among those of the main reactors and of the auxiliary engines, such as an engine, a nacelle, a pylon or an auxiliary power unit (APU), while bearing in mind that any aerial or space vehicle likely to have at least one fire zone is concerned by the invention.

### PRIOR ART

In an aircraft, many zones referred to as “fire zones” in accordance with the standard ISO 2685:1998 or AC 20-135 require using seals designed so as to ensure two main functions, the first one being a sealing function in normal flight conditions and the second being a fire-resistance (“fire-proof”) function in the event of a fire breakout or propagation in the or each considered zone of the aircraft.

In a known manner, these two functions are antagonist, given the fact that the sealing function is promoted by an increased flexibility of the seal which enables it to conform to the profile of the structural elements in contact with which it is mounted in the stressed state (pressure-barrier effect) and to simplify the installation and the tight closure of the connection by the elastic stiffness of the seal, whereas the fire-resistance function is on the contrary promoted by an increased stiffness of the seal by limiting the risk of perforation thereof by the flame (fire-barrier effect) and by limiting the transmission of heat to the other side opposite to the origin of the fire.

The sealing and fire-resistant seals designed to this end are usually made of an elastomer-fabric(s) composite by which an often unsatisfactory trade-off is achieved between these two functions, in particular for fire-resistance, and also with a significant impact resulting therefrom for the parts surrounding the sealed structural elements of the aircraft (which are usually made of a composite material or of titanium). Indeed, these parts should, on the one hand, support the stiffness of the seal constrained thereby without being deformed and, on the other hand, they often should incorporate thermal protections to guarantee fire resistance of the entirety of the considered zone including the seal and its adjacent elements.

U.S. Pat. No. 3,566,541 A discloses in FIGS. 23-28 a fire protective barrier in particular for doors and caps of containers, comprising a seal made of Neoprene® (polychloroprene) and an intumescent mass contained inside a cavity of the seal. The seal is intended to disintegrate at a flame temperature of about 204° C., and the intumescent mass is intended to swell starting from about 65° C.

A major drawback of this barrier lies in the unsuitability of the polychloroprene seal to the high temperatures in the immediate proximity of aircraft engines, which, in normal operation (i.e. fire-free environment), usually vary between −55 and 250° C. Indeed, the intumescent mass according to this document would be the site of a premature expansion and the seal incorporating it would disintegrate in normal operation of an aircraft.

EP 2 412 409 A1 discloses a monolithic seal for a fire damper, made of an intumescent material completely covered with a profile made of a silicone elastomer, which is co-extruded in contact with this intumescent and crosslinked material without any heat supply by an UV radiation. For example, this intumescent material is formed by expandable graphite or by a silicate, and its expansion can start at a temperature of 100-110° C.

A major drawback of this monolithic seal also lies in its unsuitability to the already hot fire-free environment of aircraft engines in particular because of the premature expansion of the intumescent material, which further contributes, in this document, to sealing in the absence of fire as it is clasped by the seal.

### Disclosure of the Invention

The present invention aims to provide a seal, comprising:
a seal body at least partially elastomeric, the seal body defining at least one generally tubular or annular cavity, and
a fire-resistant structure which is distinct from the seal body and which is disposed inside said at least one cavity, the fire-resistant structure comprising at least one intumescent mass able to fill said at least one cavity in an expanded state, which in particular overcomes the aforementioned drawbacks.

To this end, a seal according to the invention is such that said at least one intumescent mass is made of a rubber composition having an intumescence trigger temperature equal to or higher than 270° C., measured by a plane-plane rotary rheometer with a temperature scan from 23 to 380° C. according to a temperature ramp of 10° C./min, with 1% of deformation and with an evolution, starting from 23° C., of the normal force Fn starting from 0.07 N and of the air gap h between the planes starting from 2 mm. This seal according to the invention is further configured to connect two structural elements to each other at a zone of an aircraft which is selected from among the main reactor and auxiliary engine zones, whose temperature in the absence of fire can vary from −55° C. to 250° C. and which is referred to as fire zone according to the standard ISO 2685:1998 or AC 20-135.

It should be noted that this seal of the invention thus integrates the sealing function in normal operation of the aircraft (i.e. at a temperature lower than 270° C. which may vary for example from −55 to 250° C.), and the two sealing and fire-barrier functions in the event of a fire in a zone of the aircraft in the immediate proximity of the seal, thanks to the expansion of said at least one intumescent mass starting from 270° C. or from a higher temperature. Indeed, the or each intumescent mass synergistically cooperates in the expanded state with the seal body that it completely fills, thereby providing an additional stiffness to the wall of the cavity of the seal body against which the or each mass bears and further effectively protecting this wall throughout the duration of the fire.

In other words, the seal of the invention with a seal body and separate intumescent mass(es) allows significantly improving the sealing and fire-barrier performances while decorrelating these two functions in normal operation of the aircraft, thanks to the non-participation of said at least one intumescent mass in the sealing function in normal operation which is promoted by being ensured only by the flexibility and elasticity of the seal body, while in the event of fire the expansion of the or each intumescent mass ensures the sealing and fire-barrier dual function by conferring an increased rigidity on the seal body throughout the duration of the fire, while limiting the heat-up of the wall of the seal body against which it bears.

It should also be noted that in addition to integrating these two antagonist functions in a joint and decorrelated manner without affecting either one neither in normal operation nor in the event of a fire, the seal of the invention allows simplifying technical constraints on the surrounding parts. Indeed, the metallic or composite structural elements connected to each other at a fire zone of the aircraft (as defined by § 2.1 of the standard ISO 2685:1998 or by the standard AC 20-135), can advantageously be designed thanks to the seal of the invention with a reduced sizing in comparison with fire-resistant structural elements of the prior art, because this seal remains more flexible in normal operation of the aircraft. And since in the event of a fire, the expansion of the intumescent mass contributes in limiting the heat-up of the wall in contact with the seal body and further improving the strength of the seal when the flame passes to the other side (as this will be discussed hereinafter), this results in that this seal of the invention allows suppressing all or part of the need for thermal protection devices on the surrounding structural elements on each side of the seal.

Advantageously, said intumescence trigger temperature may be comprised between 280 and 400° C., preferably between 320 and 360° C. and for example between 330 and 350° C.

It should be noted that these temperatures are substantially higher than the maximum temperature of about 250° C. which usually characterises the engines of aircrafts such as airplanes, in particular, which improves even more the decorrelation of the aforementioned two functions and therefore the sealing performance in normal operation, since it is thus ensured that any premature and therefore undesirable start of expansion of said at least one intumescent mass is avoided.

According to another feature of the invention, the rubber composition may have, in the expanded state, a volumetric expansion ratio equal to or higher than 800%, preferably comprised between 820 and 950% and for example between 850 and 900%, measured for 15 min, at 600° C.±10° C. in a Nabertherm® N17/HR muffle furnace with a useful volume of 17 dm³ on a test sample with a circular section with a 25 mm diameter made of the rubber composition. This expansion ratio (%) is calculated by the formula ((E_{f}-Eᵢ)/Eᵢ).100 with Eᵢ referring to the initial thickness of the test sample equal to 2 mm and E_{f} the final thickness of the test sample.

It should be noted that this very high expansion ratio advantageously allows filling the corresponding cavity of the seal body while causing the application of a multi-directional force by the or each expanded mass on the entire wall of this cavity, which allows conferring the aforementioned additional stiffness on this wall contributing to the fire-barrier function.

It should also be noted that the or each mass thus expanded by intumescence (commonly called “carbon residue” in the prior art to refer to the thermal degradation cellular residue) advantageously has for this volumetric expansion ratio a value that is high enough (of at least 800%) to obtain filling and the aforementioned stiffness of the wall, but not excessive (preferably lower than 950%) so that this expansion does not affect the mechanical properties of the carbon residue. Thus, the fire-resistant structure forming this carbon residue by intumescence contributes in making the seal resistant enough in the event of a fire, by preventing destruction thereof by the combustion and the generated vibrations, as this will be discussed hereinbelow.

According to another feature of the invention, the rubber composition may be based on (i.e. made at more than 50% by weight, preferably at more than 75% by weight and more preferably made exclusively of) at least one silicone rubber, preferably a phenyl-vinyl-methyl silicone (phenylmethyl-, vinylmethyl- and dimethylsiloxane terpolymer, abbreviated PVMQ).

Indeed, the Applicant has revealed that the use of at least one silicone rubber specifically a PVMQ type one to form most or exclusively all of the weight of the elastomer matrix of the composition of the or each intumescent mass, unexpectedly allows significantly increasing the thermal stability of the or each mass (by reducing its mass loss when temperature increases beyond 600° C., for example), in comparison with other silicone rubbers such as vinylmethyl silicones (VMQ).

It should be noted that the silicone rubber preferably used in the rubber composition allows significantly improving the fire resistance of the or each intumescent mass at very high temperatures which may reach 1,100° C., typically, while complying with the operating temperature range of the seal and of the structural elements that it connects in the considered fire zone of the aircraft.

Nevertheless, it should be noted that the vinyl-methyl silicone (VMQ) and fluorosilicone (FVMQ) rubbers can also be used in the composition of said at least one intumescent mass, even though PVMQs are preferred.

According to a preferred embodiment of the invention, the rubber composition further comprises:
an expandable organic or inorganic material able to confer said intumescence trigger temperature (of at least 270° C., preferably between 280 and 400° C., for example between 320 and 360° C.) on the rubber composition, preferably comprising an expandable graphite,
a flame-retardant system, comprising fireproof agents,
optionally a reinforcing charge, and
a crosslinking system comprising a peroxide.

Advantageously, the rubber composition forming said at least one intumescent mass is not totally crosslinked, which rubber composition may be non-crosslinked or else only partially crosslinked. Preferably, the rubber composition that incorporates this crosslinking system according to a reduced amount of peroxide is crosslinked only slightly (by heating at a temperature for example comprised between 160 and 220° C.). Indeed, the Applicant has noticed a significant improvement of the mechanical properties of the carbon residue resulting from the expansion of a composition according to the invention that is not totally crosslinked inside the cavity of the seal, whereas a totally crosslinked composition has not been capable of expanding enough therein.

It should be noted that this non-totally crosslinked rubber composition is supposed to be flexible enough so that the or each intumescent mass may be inserted inside the cavity of the seal while resisting the possible deformations of the seal throughout the different phases of its service life, including in particular storage thereof and mounting thereof on the aircraft.

According to an example of this preferred embodiment of the invention, the rubber composition comprises for 100 pce of said at least one silicone rubber (pce: parts by weight for 100 parts of elastomer(s)):
said expandable organic or inorganic material according to an amount comprised between 10 and 20 pce, preferably between 13 and 17 pce of said expandable graphite,
said flame-retardant system according to an amount comprised between 10 and 20 pce, said flame-retardant system comprising for example:
   quartz according to a mass fraction from 15 to 40%,
   a metal oxide according to a mass fraction from 15 to 40%, such as titanium dioxide,
   dimethyl siloxane with a dimethylvinyl terminal group according to a mass fraction from 15 to 40%, and
   platinum according to a mass fraction lower than 0.02% and preferably comprised between 50 and 200 ppm;
as said optional reinforcing charge, mineral fibres such as rock fibres, according to an amount comprised between 18 and 28 pce; and
said peroxide according to an amount comprised between 0.05 and 0.5 pce, for example between 0.1 and 0.3 pce, said peroxide preferably being an aromatic organic peroxide, for example a dicumyl peroxide.

It should be noted that the quartz, the metal oxide, the dimethyl siloxane with a dimethylvinyl terminal group and the platinum mentioned hereinabove are mentioned without limitation, bearing in mind that other fireproof agents selected from among cerium hydroxide, dimethyl siloxane with a hydroxyl terminal group, dimethyl, methylvinyl siloxane with a dimethylvinyl terminal group, carbon black and mixtures of at least two of these other agents, can also be used in said flame-retardant system by being dispersed beforehand in a silicone oil.

Alternatively, it is possible to use in said flame-retardant system an ammonium polyphosphate solution, for example mixed with pentaerythritol and with melamine, in particular.

It should also be noted that the aforementioned amount of expandable graphite of 10-20 pce (preferably of 13-17 pce) unexpectedly allows achieving a trade-off between the volumetric expansion ratio of the rubber composition in the expanded state and the mechanical properties obtained for the carbon residue generated by this expanded composition, bearing in mind that an increase in the used amount of expandable graphite results not only in raising this expansion ratio, but also in reducing the mechanical properties of the carbon residue.

It should further be noted that the rubber composition according to the invention may be devoid of any reinforcing charge, and that the possible use of the aforementioned mineral fibres in the composition can allow mechanically reinforcing the carbon residue formed upon expansion of this composition which contains the peroxide (for example dicumyl peroxide) according to the reduced amount of 0.05-0.5 pce, preferably of 0.1-0.3 pce, to limit the subsequent hot creeping of the rubber composition without affecting expansion thereof by intumescence.

Advantageously, the rubber composition may have, in the non-crosslinked state, a Mooney viscosity ML(1+4) at 40° C., measured according to the standard ASTM D-1646, which is comprised between 15 and 25 and for example between 18 and 22.

It should be noted that these Mooney viscosity ranges for the non-crosslinked rubber composition demonstrate its ability to be implemented (i.e. shaped according to a determined shape) following mixing thereof, possibly before the partial crosslinking thereof under heat.

According to another aspect of the invention, the rubber composition of the or each intumescent mass, in the expanded state, advantageously withstands the vertical flame test according to the standard FAR25.853, Appendix F part I (a) (1) (i), the rubber composition then having no residual flame after removal of a methane flame at 843° C. for a flammability time of 60 seconds.

It should be noted that this absence of residual flame upon completion of this vertical flame test (in which the tested samples are supported vertically, as specifically described in this standard FAR25.853, Appendix F part I (b) (1) to (4)), which may be reflected by the fact that the expanded and ignited rubber composition is extinguished directly after removal of the methane flame generated by a burner, demonstrates the reduced flammability of the or each intumescent mass according to the invention.

According to a particular embodiment of the invention, the fire-resistant structure further may comprise an envelope which is separated from the seal body and which encapsulates said at least one intumescent mass in particular to protect it from surrounding fluids, the envelope being for example based on a non-crosslinked silicone rubber and may form a “skin” in contact with the or each mass.

It should be noted that this protective encapsulation of the or each intumescent mass by such an envelope may further allow limiting the movement of this mass inside the corresponding cavity of the seal, in normal operation of the aircraft.

According to another feature of the invention, the fire-resistant structure may be disposed over an inner zone of the seal body independent of the tightness ensured by the seal without the fire-resistant structure being fastened to the seal body.

It should be noted that this separate arrangement (i.e. not fastened) of the fire-resistant structure on the seal body may be reflected by an absence of physical or chemical adhesion between the fire-resistant structure and the seal body, until intumescence of the or each mass.

According to another feature of the invention, the fire-resistant structure may have, in a non-expanded state before intumescence of the or each mass, any geometry for example a generally parallelepiped one (i.e. a prismatic type one), preferably defined in this case by a width along a transverse dimension of said at least one cavity, by a height perpendicular to and smaller than said width and by a length for example equal to that of said at least one cavity.

Alternatively, the fire-resistant structure may have any other elongate geometry extending over the length of the seal body, for example generally cylindrical with a circular section, or not.

According to another feature of the invention, the seal body may be entirely or partially made of an elastomeric material based on at least one silicone rubber, preferably a terpolymer derived from phenylmethyl-, vinylmethyl- and dimethylsiloxane (PVMQ). This elastomeric material of the seal body may be made at more than 50% by weight, preferably at more than 75% by weight and more preferably made exclusively of said at least one silicone rubber.

It should be noted that the silicone rubber used in the elastomeric material of the seal body allows significantly improving its fire resistance at very high temperatures up to 1,100° C., typically, in the considered fire zone of the aircraft.

It should also be noted that fluorosilicone rubbers (FVMQ) cannot be used in the elastomeric material of the seal body.

According to preferred embodiments of the invention, the seal body is for example selected from among tubular seals with an Ω-like cross-section, a P-like cross-section, and from among annular bellows for conduits.

It should be noted that other geometries can be used for the seal body, in particular among those commonly used for seals on the aeronautical industry.

According to a particular embodiment of the invention, the seal body may be made of said elastomeric material, being devoid of a reinforcing layer embedded in said elastomeric material.

It should be noted that this exclusively elastomeric structure of the seal body has the advantage of a simplified manufacture of the latter which may be implemented by a unique extrusion step, for example.

According to another embodiment of the invention, the seal body may be made of a composite comprising said elastomeric material and at least one ply of a fabric, said at least one ply being embedded in said elastomeric material and being selected from among glass fabrics, aromatic polyamide fabrics (for example of aramid) and combinations thereof.

It should be noted that this composite structure of the seal body, obtained by a common confection method, thus requires one or more plies (respectively consisting of identical or different fabrics), the or each fabric should have enough resistance at temperatures of about 1,100° C. in the event of a fire.

For example, it is possible to use a unique glass fabric ply to reinforce the seal body, bearing in mind that this reduced reinforcement of the seal body is advantageously compensated by the intumescence capability of the fire-resistant structure and by the mechanical properties of the carbon residue obtained after intumescence, upon exposure to fire.

According to another general aspect of the invention which may be combined with any one of the aforementioned features and examples of the seal (including the seal body and/or the fire-resistant structure), the seal withstands fire according to the standard ISO 2685:1998, being capable of resisting for 15 minutes:
the heat generated by a kerosene calibrated flame at 1,100° C.±80° C. with a heat flux density absorbed by the standardised apparatus described in B.4.2 of the standard ISO 2685:1998 which is 116±10 kW/m², and
to vibrations of 50 Hz and 0.8 mm peak-to-peak as described in the standard ISO 2685:1998.

A seal according to the invention also withstands fire according to the standard AC 20-135, by being capable of resisting for 15 minutes:
the heat generated by a kerosene calibrated flame at 1,093° C.±83° C. with a heat flux density of at least 105,62±10 kW/m², and
vibrations of 50 Hz and 0.8 mm peak-to-peak.

It should be noted that this satisfactory resistance to heat and vibrations during the 15 minutes of the fire test, as specifically described in the standard ISO 2685:1998 or AC 20-135, demonstrates the fact that the combination according to the invention of the seal body and of the fire-resistant structure forming the aforementioned carbon residue by intumescence allows making the seal resistant enough in the event of a fire, by preventing destruction or disintegration thereof by the combustion and the vibrations generated by the fire.

An aircraft according to the invention, in particular an airplane or a helicopter, comprises:
at least one pair of metallic or composite structural elements configured to be connected to each other at least at one zone of the aircraft referred to as fire zone for example according to § 2.1 of the standard ISO 2685:1998 or AC 20-135, said at least one zone being preferably selected from among the main reactor and auxiliary engine zones of the aircraft, such as the zones of an engine, a nacelle, a pylon and/or an auxiliary power unit (GAP in French, APU in English standing for “Auxiliary Power Unit”), and
at least one seal which tightly connects the structural elements of said at least one pair to each other,
   and according to the invention said at least one seal is as defined hereinabove.

It should be noted that said at least one fire zone of the aircraft, such as an aerial or space vehicle, may be defined in a way other than according to the standard ISO 2685:1998 or AC 20-135, and that it may thus concern zones other than those identified hereinabove.

### BRIEF DESCRIPTION OF THE DRAWINGS

Other features, advantages and details of the present invention will appear upon reading the following description of several embodiments of the invention, provided for illustrative and non-limiting purposes with reference to the appended drawings, among which:

FIG. 1 is a schematic cross-sectional view of an Ω-like seal according to an example of the invention mounted between and against two structural elements to be sealed in an aircraft, in normal operation of the seal (i.e. with no fire in the aircraft), the fire-resistant structure of the seal not being expanded.

FIG. 2 is a schematic cross-sectional view of the seal of FIG. 1 forming a fire barrier in the event of a fire in the aircraft, the fire-resistant structure of the seal being expanded.

FIG. 3 is a schematic cross-sectional view of an Ω-like seal according to the invention similar to the example of FIG. 1 in normal operation of the seal, the fire-resistant structure of the seal not being expanded.

FIG. 4 is a schematic cross-sectional view of a P-like seal according to a variant of the invention, in normal operation of the seal, the fire-resistant structure of the seal not being expanded.

FIG. 5 is a schematic cross-sectional view of a seal according to another variant of the invention forming a bellow for conduits, in normal operation of the seal, the fire-resistant structure of the seal not being expanded.

FIG. 6 is a detail cross-sectional view of a seal body similar to that of FIG. 1, the seal being shown at rest and devoid of a fire-resistant structure with its dimensions expressed in mm.

FIG. 7 is a schematic cross-sectional view of a “control” seal at rest formed by the seal body of FIG. 6 with no fire-resistant structure, this “control” seal having undergone fire tests according to the standard ISO 2685:1998.

FIG. 8 is a schematic cross-sectional view of a seal according to the invention at rest formed by the seal body of FIG. 6 and by a fire-resistant structure, this seal having also undergone fire tests according to the standard ISO 2685:1998.

FIG. 9 is a photograph showing an open end of the seal of FIG. 8 in the deformed state over its lower base, which is topped by the non-expanded fire-resistant structure.

FIG. 10 is a graph illustrating the evolution as a function of temperature, measured by thermogravimetric analysis (TGA), of the weight of a first composition according to the invention based on a silicone rubber PVMQ (curve in solid line), in comparison with a second composition according to the invention based on a silicone rubber VMQ (curve in dotted line), each composition forming a fire-resistant structure of the seal of FIGS. 8-9 and of the carbon residue resulting therefrom.

FIG. 11 is a graph illustrating the evolution as a function of temperature, measured through an analysis using a plane/plane rheometer, of the normal force Fn (lower curve) and of the inter-plate distance h (upper curve) of the first rubber composition according to the invention based on a PVMQ forming the fire-resistant structure of the seal of FIGS. 8-9 and of the carbon residue resulting therefrom.

FIG. 12 is a schematic view of a fire test bench according to the standard ISO 2685:1998 used for fire tests on the “control” seals and according to the invention of FIGS. 7 and 8-9, showing a seal sample, the burner and the main devices and corresponding steps used in this test bench.

FIG. 13 is a schematic view of a camera system disposed on both sides of the test device, inside the test bench of FIG. 12.

FIG. 14 is a detail view of the test bench of FIG. 12 showing two structural elements for compressing each “control” seal sample or according to the invention, and the direction of the impact of flame generated by the burner during each fire test.

FIG. 15 contains seven photographs showing a seal sample according to FIGS. 8-9 of the invention and the structural elements adjacent to this sample, upon completion of a fire test implemented according to the standard ISO 2685:1998.

FIG. 16 contains three photographs showing a “control” seal sample according to FIG. 7 and the structural elements adjacent to this sample, upon completion of a fire test implemented according to the standard ISO 2685:1998.

### EMBODIMENTS OF THE INVENTION

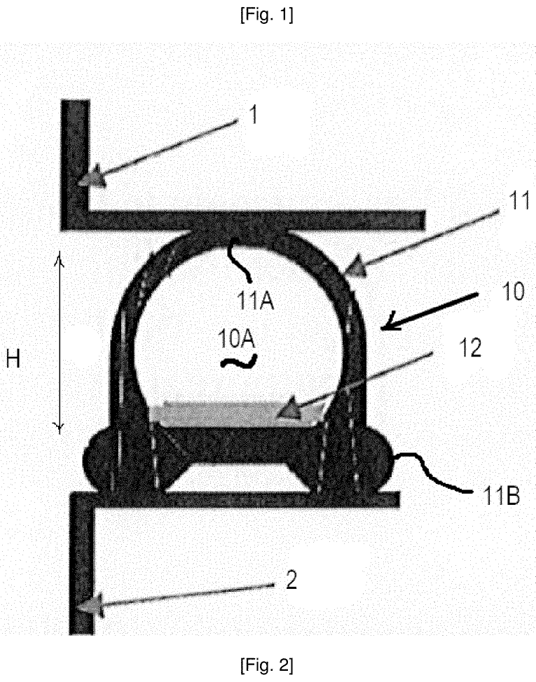

The seal 10 according to the invention visible in FIG. 1 is mounted compressed between two opposing structural elements 1 and 2 to be sealed, and it comprises:
a tubular seal body 11 with a closed Ω-like cross-section, defining a cavity 10A between its rounded top 11A and its planar base 11B which tightly bear against the elements 1 and 2, respectively, and
a fire-resistant structure 12 disposed in this example over the inner face of the base 11B of the seal body 11, over the entire transverse width of the base 11B (in contact with the rounded wall of the cavity 10A on top of the base 11B) and which occupies in the non-expanded state and at rest of the seal body 11 a reduced fraction of the transverse height H of the cavity 10A.

Only for indication, the fire-resistant structure 12 has, for example, a rectangular section (i.e. a generally parallelepiped geometry over the length of the cavity 10A), and this fraction occupied by the fire-resistant structure 12 is, for example, comprised between only 5 and 20% of said height H (which is defined from the inner face of the base 11B to that of the top 11A of the cavity 10A).

As explained hereinabove, the seal body 11 is, for example, entirely or partially made of an elastomeric material based on a silicone rubber, in which material is optionally embedded at least one reinforcing fabric ply. As regards the fire-resistant structure 12, it is, for example, made of an intumescent mass formed by a rubber composition based on a silicone rubber and further comprising:
an expandable organic or inorganic material able to confer an intumescence trigger temperature of at least 270° C. on the composition, preferably consisting of an expandable graphite,
a flame-retardant system comprising fireproof agents,
optionally a reinforcing charge, and
a hot-crosslinking system comprising a peroxide.

After intumescence of the fire-resistant structure 12 in the event of a fire on-board the aircraft, one could see in FIG. 2 that the structure 12 occupies in the expanded state substantially the entirety of the height H and of the inner volume of the cavity 10A, also with the application of a multi-directional force (generally radial in this example) on the wall of the cavity 10A by the expanded structure 12, which is reduced to a carbonized state by the combustion reaction, which results in conferring an additional stiffness on the seal body 11 in the event of a fire.

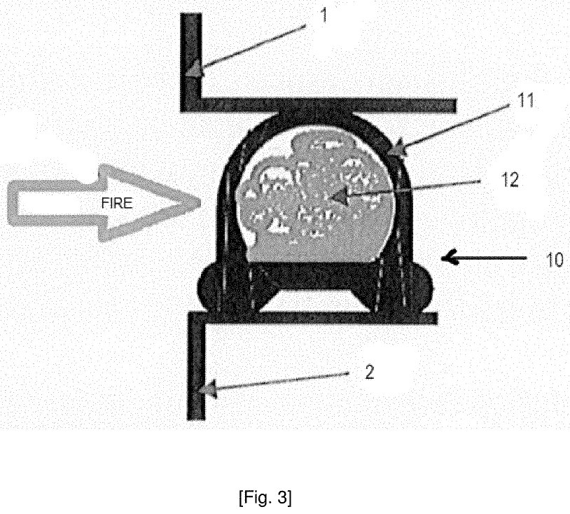

The Ω-like seal 10 according to the invention visible in FIG. 3 differs from that of FIG. 1 essentially in that its fire-resistant structure 12 is wedged between two vertical spurs 11a and 11b connecting the inner face 11c of the base 11B to the rounded portion of the cavity 10A.

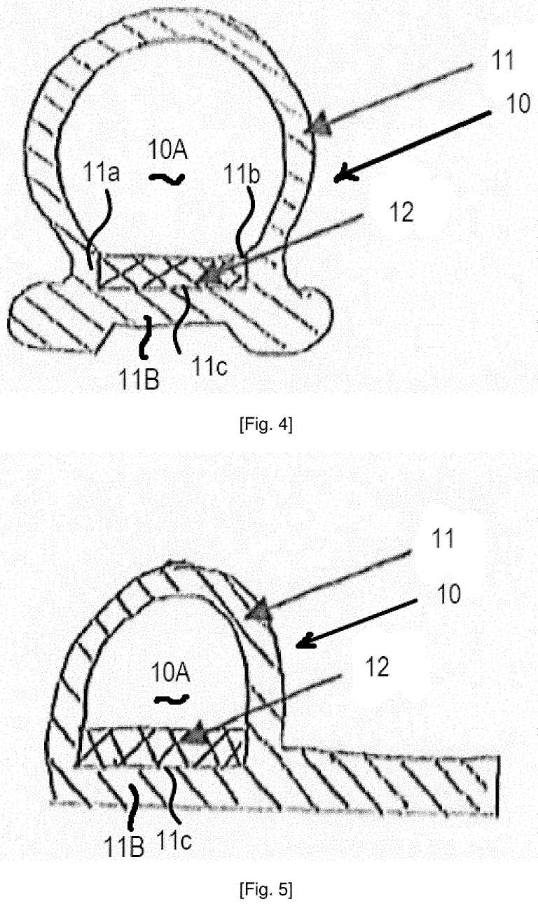

The seal 10 according to the invention visible in FIG. 4 comprises a P-like seal body 11, and a fire-resistant structure 12 for example with a rectangular section disposed inside the tubular cavity 10A of the “P”, over the inner face 11c of a base 11B of this cavity 10A (i.e. in the continuation of the leg of the “P”). As shown in FIG. 4, the fire-resistant structure 12 may be mounted, possibly with some clearance, in contact with the rounded wall of the cavity 10A of the “P”.

The seal 10 according to the invention visible in FIG. 5 is of the bellow type for two radially inner and outer conduits, respectively. The seal 10 comprises a two-walled seal body 11, and a fire-resistant structure 12 formed by a coating disposed inside the annular cavity 10A, over an inner face of the outer wall 11B′ of the seal body 11. Thus, the fire-resistant structure 12 can extend over the entire circumference of the outer wall 11B′ of the seal 10.

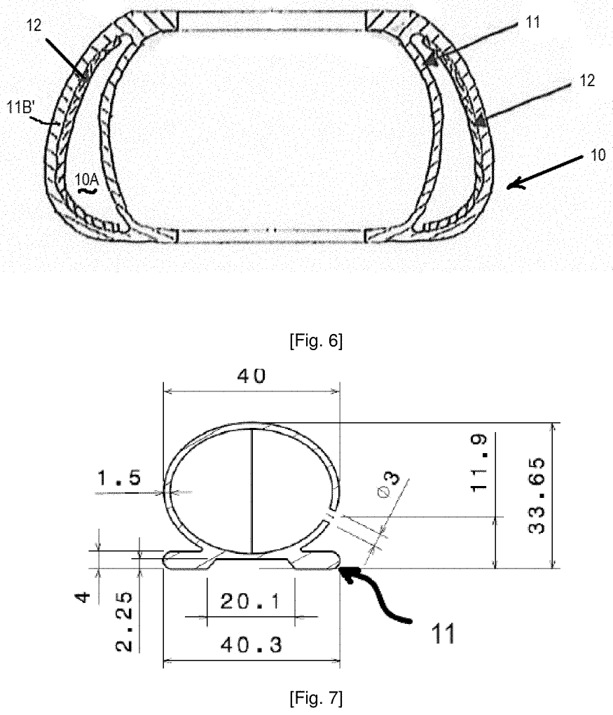

The Ω-like seal body illustrated in FIG. 6 is similar to the seal body 11 of FIG. 1, with:
its generally planar base 11B provided over its outer face with a pair of external mount feet (lower feet in FIG. 6, defining an outer transverse width of 40.3 mm for the base) for mounting the seal body 11 bearing on a structural element 2 such as that of FIG. 1, and
its rounded wall defining the cavity 10A from this base 11B, this wall (with a 1.5 mm thickness) being in this example generally in the form of an ellipse with a major axis (i.e. transverse width) equal to 40 mm and with a minor axis (i.e. transverse height) equal to about 29 mm, and laterally having a circular orifice.

As illustrated in FIG. 7, samples of a seal body 11 have been made according to the geometry and the dimensions of FIG. 6 by embedding, in an elastomeric material based on a silicone rubber PVMQ, a ply 11d of a glass fabric, so that the ply 11d extends in the mass of the rounded wall of the cavity 10A over its elliptical circumference and over the length of the cavity 10A. Thus, samples of the “control” seal of FIG. 7 have been obtained, consisting of only this rubber body 11 (with no fire-resistant structure therein).

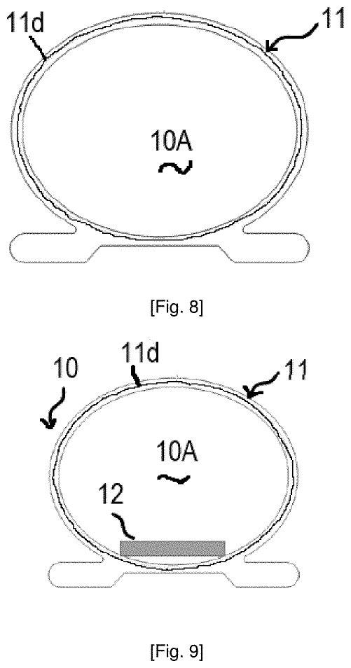

As illustrated in FIG. 8, a fire-resistant structure 12 according to the invention, i.e. as described hereinabove with reference to FIG. 1, has been added to the seal body 11 of FIG. 7 (made of an elastomeric material based on said silicone rubber, in which a glass fabric ply 11d is embedded for reinforcement thereof). The fire-resistant structure 12 consisted of an intumescent mass with a generally rectangular section (i.e. with a generally parallelepiped geometry over the length of the cavity 10A), with a width and a height of 20 mm and 6 mm, respectively. Thus, samples of the seal 10 according to the invention of FIG. 8 have been obtained, formed by the same seal body 11 as in FIG. 7 and by the fire-resistant structure 12 therein, this seal 10 being visible in the photograph of FIG. 9.

The intumescent mass of the fire-resistant structure 12 of this seal 10 according to the invention has been prepared as described hereinafter.

The formulation of this intumescent mass is indicated in Table 1 hereinafter, representative of an example of said first composition according to the invention.

TABLE 1

| | | Formulation |
|---|---|---|
| Nature of the products | Characteristics | (pce) |
| Flame-retardant system | cf. Table 2 | 15.40 |
| Silicon rubber | PVMQ | 100.00 |
| Expandable graphite | GHL 95 HT 270 | 15.40 |
| Mineral fibres | “LAPINUS” CF-50 | 23.10 |
| Crosslinking agent | Dicumyl peroxide | 0.2 |

| | |
|---|---|
| Total (pce) | 154.1 |

More specifically, amongst these ingredients:
the PVMQ silicone (as defined in ASTM D-1418, also called PMVQ) was a phenyl polydimethylsiloxane (phenylmethyl-, vinylmethyl- and dimethylsiloxane terpolymer which, in the non-crosslinked state, was translucent, had a density of 1.22±0.03, and a Williams plasticity measured according to ASTM 926 equal to 400),
the GHL 95 HT 270 was a graphite grade expandable at a trigger temperature of 270° C.,
the “Lapinus” CF 50 reinforcing mineral fibres of the composition consisted of rock fibres with an average length of 500+/−150 μm and a diameter D90 of 7 μm, and
the used flame-retardant system was a mixture of several compounds and fireproof agents pre-dispersed in a silicone oil, to facilitate dispersal thereof upon mixing of the rubber composition.

The composition of the flame-retardant system is indicated in Table 2 hereinafter.

TABLE 2

| | Mass |
|---|---|
| Flame-retardant system | fractions (%) |
| Quartz - titanium dioxide - carbon black | 40.0-70.0 |
| Dimethyl siloxane, with a dimethylvinyl end | 15.0-40.0 |
| Cerium hydroxide | 3.0-7.0 |
| Polydimethyl siloxane with a hydroxy end | 3.0-7.0 |
| Dimethyl, methylvinyl siloxane, with a | 3.0-7.0 |
| dimethylvinyl end | |
| Platinum | 115 ppm |

The following properties of the rubber composition obtained by thermomechanical mixing of the aforementioned ingredients have been measured, whose values are reported in Table 3 hereinafter. For this mixing, a Haake® tangential mixer with a useful volume of 250 cm3 with a fill coefficient equal to 1 has been used, this mixing having been implemented at a temperature of 30° C. for a mixing duration of 2 min. 30 s.

TABLE 3
Properties of the obtained rubber composition

| | |
|---|---|
| ML(1 + 4) Mooney viscosity at | 20 points |
| 40° C. | |
| Volumetric expansion ratio after | 875% |
| intumescence in the oven (15 min. | |
| at 600° C.) | |
| Mechanical properties of the carbon | Limited - brittle |
| residue obtained by intumescence | carbon residue |
| (qualitative) | |
| Creeping in the oven, without load: | 0% |
| 1 h at 250° C. | |
| Vertical flame test according to the | No residual flame - |
| standard FAR25.853 Appendix F part | the mixture is extinguished |
| 1 (a) (1) (i): flammability time of | directly after removal of |
| 60 seconds | the methane flame |

These properties of the obtained rubber composition in the non-crosslinked (Mooney viscosity and creeping) and partially crosslinked (expansion ratio, mechanical properties and flammability) were well suited for the obtainment of a fire barrier of the seal 10 according to the invention incorporating a fire-resistant structure 12 made of this composition.

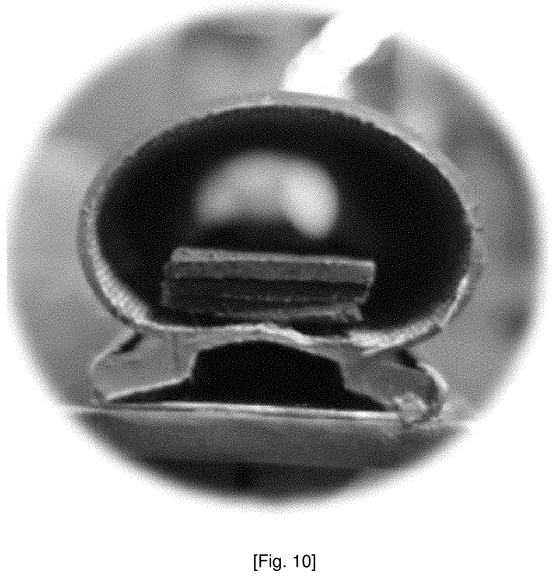

FIG. 10 illustrates the result of a TGA analysis (performed under N₂ with a temperature ramp of 20° C./min.) showing the weight loss with the temperature of two intumescent rubber compositions according to the invention, the first composition being based on the aforementioned PVMQ and the second composition based on a VMQ. The VMQ used for the second composition, in the non-crosslinked state, was a colourless solid with a volumetric mass of 1.10 g/cm3 (measured according to the standard DIN 53 479 A) and with a ML(4) viscosity at 25° C. equal to 26, and this second composition had, except for VMQ, the same formulation in terms of ingredients and amounts as that of the first compositions of Tables 1-2 based on PVMQ.

This TGA analysis of FIG. 10 shows that the first composition based on PVMQ has a heavier residue after thermal degradation than that of the second composition based on VMQ. More specifically, one can see in this graph that starting from about 600° C. the weight of the PVMQ-based residue decreases less rapidly with temperature than is the case for the VMQ-based residue, with a weight loss of about 25% for the PVMQ-based residue compared to about 40% for the VMQ-based residue at 900° C. Thus, the Applicant has demonstrated that the addition of the phenyl group in the polymeric chain of the silicone rubber increases the thermal stability of the intumescent mass.

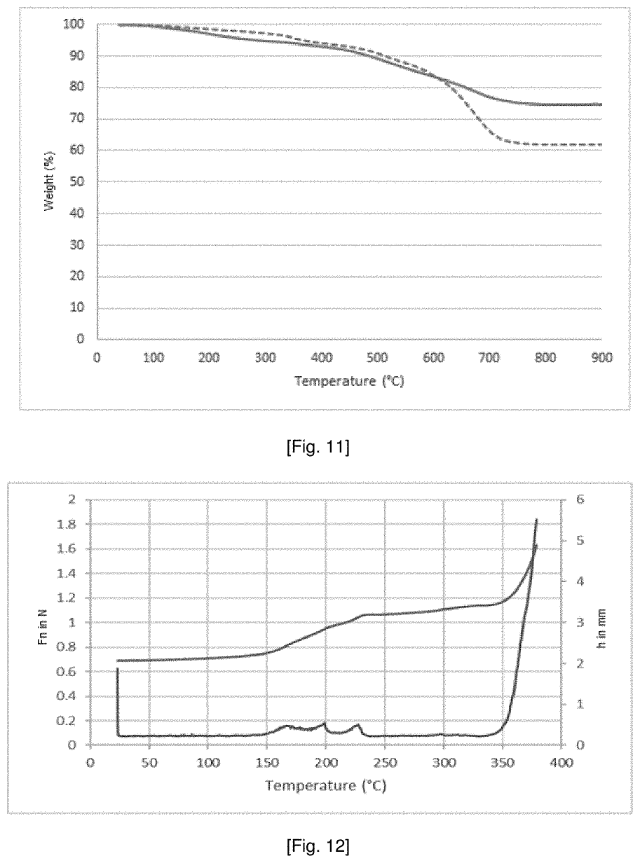

As illustrated in FIG. 11, the analysis using a plane/plane rheometer of the first rubber composition according to the invention based on PVMQ according to Tables 1-3, with a temperature scan from 23 to 380° C. according to a temperature ramp of 10° C./min, with 1% of deformation and by control of the normal force (Fn of 0.07 N, namely a pressure of 200 Pa), has shown the following two transitions:
between 160 and 220° C., a first transition corresponding to a partial crosslinking of the rubber composition, and
starting from about 340° C., a second transition corresponding to the expansion of the rubber composition.

The analysis illustrated by FIG. 11 demonstrates that triggering of the intumescence of the first rubber composition has occurred beyond 270° C., at least at 340° C. This graph further demonstrates that the normal force exerted on the upper plate during the expansion of the first rubber composition was linear and progressive, and that the mechanical integrity of the expanded first composition according to the invention has been preserved until the end of the analysis.

For the fire tests concerning the seal 10 according to the invention of FIGS. 8-9 and 10-11 with the fire-resistant structure 12 described hereinabove with reference to Tables 1-3, on the one hand, and concerning the “control” seal 11 of FIG. 7 devoid of a fire-resistant structure, on the other hand, a test bench according to the standard ISO 2685:1998 which is schematized in FIG. 12 and which shows in particular, related to each tested “control seal ample and according to the invention:

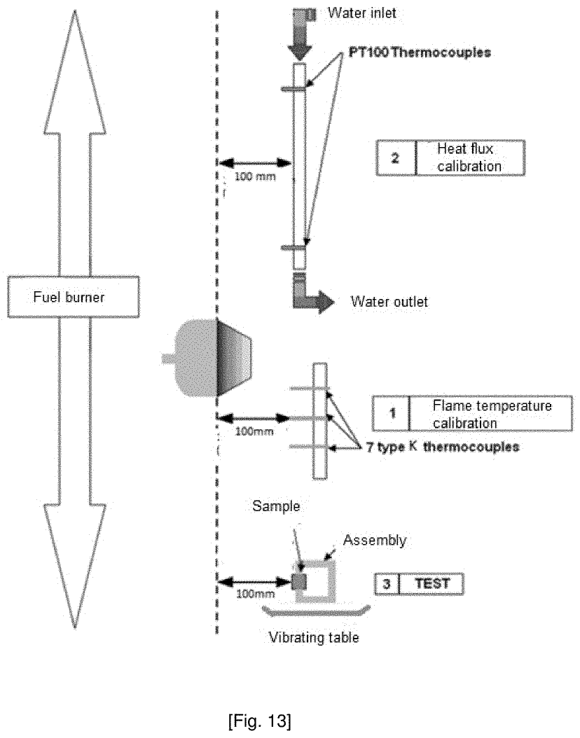

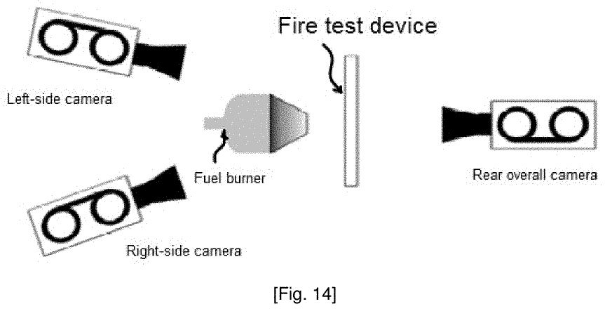

a) a fuel (i.e. kerosene) burner,
b) a K-type thermocouple for measuring temperature during step 1 of calibrating the flame generated by the burner, these K thermocouples being remote by 100 mm from the burner,
c) a calorimetric device, comprising a copper tube and PT 100 type thermocouple forming a calorimeter used for calculating the heat flux in order to calibrate the flame during step 2 of calibrating the heat flux of the flame, and a flowmeter for measuring the water flow rate in this tube during step 2,
d) a digital camera and three video cameras (arranged at the front and at the rear of the test device), which cameras are visible in FIG. 13,
e) a test device (visible in FIG. 14) comprising an assembly and setting wedges supporting each seal sample to be tested during the test step 3 compressed, at a distance of 100 mm from the burner, and
f) a vibrating table for imparting to each tested sample the vibrations required by the standard ISO 2685:1998.

The monitored conditions for these fire tests being those prescribed in the standard ISO 2685:1998, they will not be detailed hereinafter, while pointing out that each fire test, implemented for 15 minutes, has subjected the tested seal sample to:

(i) the heat generated by a kerosene calibrated flame at 1,100° C.±80° C. with a heat flux density absorbed by the standardised apparatus described in B.4.2 of the standard ISO 2685:1998 which is 116±10 kW/m², and to
(ii) vibrations of 50 Hz and 0.8 mm peak-to-peak as described in this same standard.

A thermal camera has been disposed at the rear of each assembly to measure the temperatures at the rear of each tested “control” sample and according to the invention (i.e. on the side opposite to the flame, cf. the left side of FIG. 13 with respect to the test device equipped with the two video cameras), and the temperatures reported in Table 4 hereinafter have thus been obtained for the rear face of each sample as a function of the elapsed fire time (from 1 to 16 minutes).

TABLE 4

| | Temperature at | |
|---|---|---|
| | the rear of the | Temperature at |
| Elapsed fire | seal according to | the rear of the |
| time | the invention | “control” seal |
| (min.) | (° C.) | (° C.) |
| 1 | — | 125.3 |
| 2 | 166.2 | 161.8 |
| 3 | 180.4 | 172.4 |
| 4 | 189.1 | 215.9 |
| 5 | 202.3 | 244.4 |
| 6 | 225.1 | 265.9 |
| 7 | 244.8 | 288.6 |
| 8 | 263.1 | 320.7 |
| 9 | 276.2 | 343.6 |
| 10 | 290.0 | 340.3 |
| 11 | 304.0 | 351.5 |
| 12 | 314.7 | 397.1 |
| 13 | 324.3 | — |
| 14 | 331.0 | — |
| 15 | 333.4 | — |
| 16 | 326.7 | |

These measurements of temperature at the rear of each seal sample have revealed:
for the “control” seal sample, the destruction (i.e. disintegration by combustion of its rear face opposite to the flame) of the seal after 12 minutes and 19 seconds of the fire test, and
for the seal sample according to the invention, the successful conclusion of the fire test given that this sample has preserved its rear face after 15 minutes of the fire test (this rear face, not destroyed, was at a moderate temperature of about 330° C. after 15 minutes, in comparison with the temperature of about 400° C. of the rear face of the “control” seal after 12 minutes).

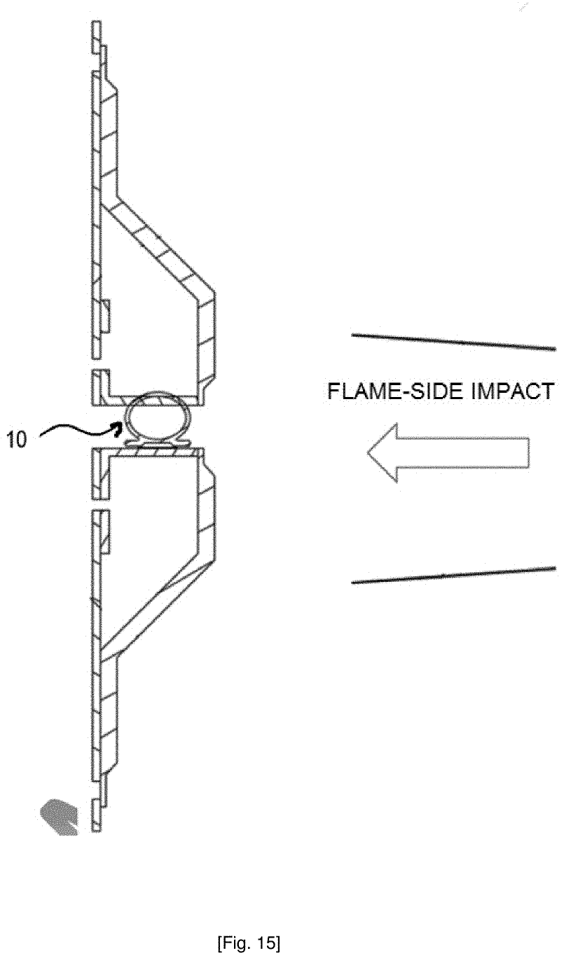

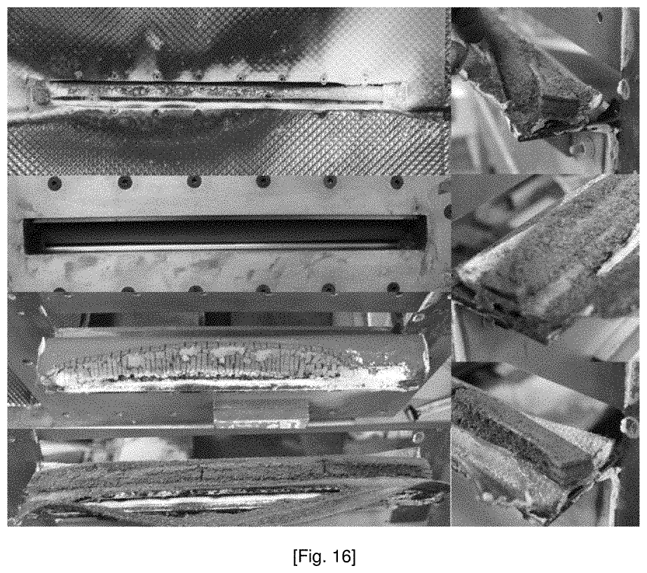

To conclude, and as this is confirmed by the photographs of FIGS. 15-16, the seal 10 according to the invention with a fire-resistant structure 12 has a fire resistance (barrier effect and protection of the seal body 11 by limiting the heat-up of its wall) that is very significantly improved in comparison with the “control” seal without the fire-resistant structure.

Indeed, one could see in FIG. 15 that after the 15 min. of testing, the rear face of the body 11 of the seal 10 according to the invention has not been disintegrated (cf. in FIG. 15 the third photograph to the left starting from the top), the same applies to the carbon residue forming the residue of the fire-resistant structure 12 which has served as a fire-barrier in contact with the seal body 11 (this carbon residue according to the invention is visible in the photograph at the bottom to the left and in the three photographs to the right of FIG. 15). Unlike the seal 10 according to the invention, the “control” seal 11 has its rear face largely destroyed after the 12 min. of the fire test, as visible in the third photograph of FIG. 16 starting from the top.

1. A seal (10), comprising:
a seal body (11) at least partially elastomeric, the seal body (11) defining at least one generally tubular or annular cavity (10A), and
a fire-resistant structure (12) which is distinct from the seal body (11) and which is disposed inside said at least one cavity (10A), the fire-resistant structure (12) comprising at least one intumescent mass able to fill said at least one cavity (10A) in an expanded state,
wherein said at least one intumescent mass is made of a rubber composition having an intumescence trigger temperature equal to or higher than 270° C., measured by a plane-plane rotary rheometer with a temperature scan from 23 to 380° C. according to a temperature ramp of 10° C./min, with 1% of deformation and with an evolution, starting from 23° C., of the normal force Fn starting from 0.07 N and of the air gap h between the planes starting from 2 mm, and
wherein the seal (10) is configured to connect two structural elements (1 and 2) to each other at a zone of an aircraft which is selected from among the main reactor and auxiliary engine zones, whose temperature in the absence of fire can vary from −55° C. to 250° C. and which is referred to as fire zone according to the standard ISO 2685:1998 or AC 20-135.

2. The seal (10) according to claim 1, wherein said intumescence trigger temperature is comprised between 280 and 400° C.

3. The seal (10) according to claim wherein the rubber composition has, in the expanded state, a volumetric expansion ratio equal to or higher than 800%, measured for 15 min, at 600° C. +/−10° C. in a Nabertherm® N17/HR muffle furnace with a useful volume equal to 17 dm³ on a test sample with a circular section with a 25 mm diameter made of the rubber composition, the expansion ratio being calculated by the formula ((E_{f}−Eᵢ)/Eᵢ)·100 with Eᵢ referring to the initial thickness of the test sample equal to 2 mm and E_{f} the final thickness of the test sample.

4. The seal (10) according to claim 1, wherein the rubber composition is based on at least one silicone rubber.

5. The seal (10) according to claim 4, wherein the rubber composition further comprises:
an expandable organic or inorganic material able to confer said intumescence trigger temperature on the rubber composition,
a flame-retardant system, comprising fireproof agents,
optionally a reinforcing charge, and
a crosslinking system comprising a peroxide, the rubber composition not being crosslinked or being only partially crosslinked.

6. The seal (10) according to claim 5, wherein the rubber composition comprises for 100 pee of said at least one silicone rubber (pce: parts by weight for 100 parts of elastomer(s)):
said expandable organic or inorganic material according to an amount comprised between 10 and 20 pce,
said flame-retardant system according to an amount comprised between 10 and 20 pce,
optionally as said reinforcing charge, mineral fibres according to an amount comprised between 18 and 28 pee; and
said peroxide according to an amount comprised between 0.05 and 0.5 pee.

7. The seal (10) according to claim 1, wherein the rubber composition has, in the non-crosslinked state, a Mooney viscosity ML(1+4) at 40° C., measured according to the standard ASTM D-1646, which is comprised between 15 and 25.

8. The seal (10) according to claim 1, wherein the rubber composition, in the expanded state, withstands the vertical flame test according to the standard FAR25.853, Appendix F part I (a) (1) (i), the rubber composition having no residual flame after removal of a methane flame for a flammability time of 60 seconds.

9. The seal (10) according to claim 1, wherein the fire-resistant structure (12) further comprises an envelope which is separated from the seal body and which encapsulates said at least one intumescent mass in particular to protect it from surrounding fluids.

10. The seal (10) according to claim 1, wherein the fire-resistant structure (12) is disposed over an inner zone of the seal body (11) independent of the tightness ensured by the seal (10) without the fire-resistant structure (12) being fastened to the seal body (11), the fire-resistant structure (12) having, in a non-expanded state before intumescence of said at least one intumescent mass, a generally parallelepiped geometry.

11. The seal (10) according to claim 1, wherein the seal body (11) is entirely or partially made of an elastomeric material based on at least one silicone rubber.

12. The seal (10) according to claim 11, wherein the seal body (11) is made of said elastomeric material, being devoid of a reinforcing layer embedded in said elastomeric material.

13. The seal (10) according to claim 11, wherein the seal body (11) is made of a composite comprising said elastomeric material and at least one ply (11d) of a fabric, said at least one ply (11d) being embedded in said elastomeric material and being selected from among glass fabrics, aromatic polyamide fabrics and combinations thereof.

14. The seal (10) according to one claim 1, wherein the seal (10) withstands fire according to the standard ISO 2685:1998, being capable of resisting for 15 minutes:
the heat generated by a kerosene calibrated flame at 1,100° C.±80° C. with a heat flux density absorbed by the standardised apparatus described in B.4.2 of the standard ISO 2685:1998 which is 116±10 kW/m², and
to vibrations of 50 Hz and 0.8 mm peak-to-peak as described in the standard ISO 2685:1998.

15. An aircraft, in particular an airplane or a helicopter, comprising:
at least one pair of metallic or composite structural elements (1 and 2) configured to be connected to each other at least at one zone of the aircraft selected from among the main reactor and auxiliary engine zones, whose temperature in the absence of fire fan vary from −55° C. to 250° C. and which is referred to as fire zone according to § 2.1 of the standard ISO 2685; 1998 or according to the standard AC 20-135, and
at least one seal (10) which tightly connects the structural elements (1 and 2) of said at least one pair to each other,
wherein said at least one seal (10) comprises:
a seal body (11) at least partially elastomeric, the seal body (11) defining at least one generally tubular or annular cavity (10A), and
a fire-resistant structure (12) which is distinct from the seal body (11) and which is disposed inside said at least one cavity (10A), the fire-resistant structure (12) comprising at least one intumescent mass able to fill said at least one cavity (10A) in an expanded state,
wherein said at least one intumescent mass is made of s rubber composition having an intumescence trigger temperature equal to or higher than 270° C. measured by a plane-piano rotary rheometer with a temperature scan from 23 to 380° C. according to a temperature ramp of 10° C./min, with 1% of deformation and with an evolution, starting from 23° C. of the normal force Fn starting from 0.07 N and of the air gap h between the planes starting from 2 mm.

16. The seal (10) according to claim 2, wherein said intumescence trigger temperature is comprised between 320 and 360° C.

17. The seal (10) according to claim 4, wherein the rubber composition is based on a terpolymer derived from phenylmethyl-, vinylmethyl- and dimethylsiloxane (PVMQ).

18. The seal (10) according to claim 5, wherein the expandable organic or inorganic material able to confer said intumescence trigger temperature on the rubber composition comprises an expandable graphite.

19. The seal (10) according to claim 6, wherein the rubber composition comprises for 100 pee of said at least one silicone rubber (pee: parts by weight for 100 parts of elastomer(s)):
between 13 and 17 pee of an expandable graphite for said expandable organic or inorganic material,
said flame-retardant system which comprises:
quartz according to a mass fraction from 15 to 40%,
a metal oxide according to a mass fraction from 15 to 40%,
dimethyl siloxane with a dimethylvinyl terminal group according to a mass fraction from 15 to 40%;
rock fibres for said mineral fibres, according to an amount comprised between 18 and 28 pce; and
said peroxide according to an amount comprised between 0.1 and 0.3 pce, said peroxide being an aromatic organic peroxide.

20. The seal (10) according to claim 9, wherein the envelope is based on a non-crosslinked silicone rubber.

21. The seal (10) according to claim 10, wherein said generally parallelepiped geometry is defined by a width along a transverse dimension of said at least one cavity (10A), by a height perpendicular to and smaller than said width and by a length equal to that of said at least one cavity (10A).

22. The seal (10) according to claim 11, wherein the seal body (11) is entirely or partially made of said elastomeric material which is based on a terpolymer derived from phenylmethyl-, vinylmethyl- and dimethylsiloxane (PVMQ), the seal body (11) being selected from among tubular seals with an Q-like cross-section, a P-like cross-section, and from among annular bellows for conduits.

23. The aircraft according to claim 15, wherein said at least one zone of the aircraft referred to as fire zone is selected from among the zones of an engine, a nacelle, a pylon and/or an auxiliary power unit.
